(19) United States
(12) Patent Application Publication
(10) Pub. No.: US 2021/0157576 A1
(43) Pub. Date: May 27, 2021

(54) Speech to Project Framework

(71) Applicant: Microsoft Technology Licensing, LLC, Redmond, WA (US)

(72) Inventors: Santosh Kumar Sinha, Redmond, WA (US); Anirban Sarkar, Bellevue, WA (US); Hardikkumar Prahladbhai Patel, Redmond, WA (US); Ashish Sayal, Redmond, WA (US)

(21) Appl. No.: 16/698,423

(22) Filed: Nov. 27, 2019

(51) Int. Cl. G06F 8/70; G06F 17/27; G10L 15/26; G06Q 10/10

(52) U.S. Cl. CPC G06F 8/70; G06Q 10/109; G10L 15/265; G06F 17/27

(57) ABSTRACT

A computer implemented method includes receiving text describing a software development project, deriving multiple project related intents from the text using natural language processing services, selecting multiple software components corresponding to the derived intents, and stitching the multiple software components to create development project code.

### BACKGROUND

Software design always plays a critical role in project development. It involves a lot of design discussion sessions, whiteboard, and design skills. Once everybody agrees on the design, a prototype is made to visualize the actual functionality of the working system. The prototype is a critical part in software development. Creating a prototype takes ample amount of time to learn new technology and manual effort to create a project with functional code which delays the overall process. Many times, creating a prototype may require few days to several weeks of effort.

### SUMMARY

A computer implemented method includes receiving text describing a software development project, deriving multiple project related intents from the text using natural language processing services, selecting multiple software components corresponding to the derived intents, and stitching the multiple software components to create development project code.

### BRIEF DESCRIPTION OF THE DRAWINGS

FIG. 1 is a block diagram of software project generating system, also referred to as a speech to project framework according to an example embodiment.

FIG. 2 is a block diagram illustrating further detail of the speech to project engine according to an example embodiment.

FIG. 3 is a flowchart illustrating a computer implemented method of generating an example project from extracted intent according to an example embodiment.

FIG. 4 is a block diagram providing further detail of a project builder engine according to an example embodiment.

FIG. 5 is a flowchart illustrating a computer implemented method of converting text representative of speech to development project code according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Various embodiments analyze speech related to a software development project, generate text, determine intent reflected in the text and select a programming template most appropriate for the intent, download the template to the user computer, and publish the solution such that the user is able to immediately execute the template. In one embodiment, a template is a generic unit of source code that can be used as the basis for unique units of code, it provides a way of reusing a code. The template may include server, client, and database portions. In one embodiment, a raw meeting room discussion may be recorded, transcribed, and transformed into a full functional prototype project, greatly reducing the amount of time normally required to create a prototype following a meeting. A project is a set of files that are compiled into an executable, library or web application, etc., for a specific outcome to achieve a particular goal. Files may contain source code, icons, images, data, etc.

In one embodiment, a speech to project framework can take the input from the external customer and quickly create a simple web application with enterprise Azure Active Directory integrated into the application. The framework can auto-deploy the new web application to Azure to show easy to integrate technologies starting from a development application to a cloud-based application.

A team that is starting a brand-new project may bring team members to a meeting room to discuss what kind of solution they need. The application can be a web application (MVC (Model View Controller), ASP (Active Service Provider). Net React or Angular) with a database of CRUD (create read update delete) operations. The speech to project framework can listen to team conversation and provide a project solution based on the needs with built-in DB (database) connector, secured ways to keep secrets all built on SOLID (software library for interference detection) engineering principles.

A user may need a quick application/solution to capture a customized survey. Using the speech to project, the user can give audio instructions to create a survey web application deployed to Azure and provide a URL for the created survey web application (uniform resource locator) that can be shared with team members.

A team that is looking for an application using cloud resources for a given initiative may bring all the team member to the meeting room to discuss the requirements. The speech or text to project framework can listen to team conversation & can provide the solution based on the needs with built-in DB connector etc.

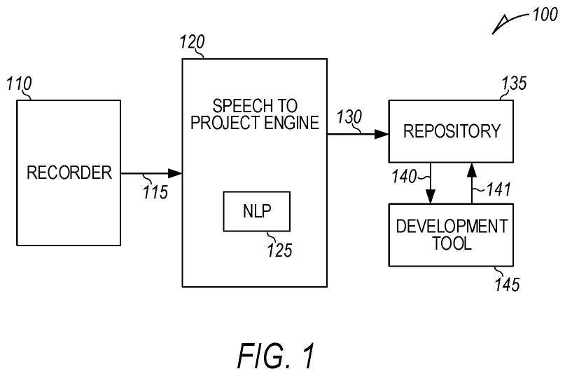

FIG. 1 is a block diagram of software project generating system 100, also referred to as a speech or text to project framework, for generating a code template and code based on natural language text. The text may be written text or text generated from captured speech. In one embodiment, a recorder 110 is used to capture speech from a single person or spoken by one or more people during a meeting. The recorder 110 may be an audio recorder that is part of a meeting tool, such as Microsoft Teams, Skype, or Zoom, or a personal assistant such as Cortana, or even from a user mobile device capturing a recording of a meeting or dictation. Many other means of capturing audio may be used.

In one embodiment, a software development platform, such as Visual Studio®, may have an extension for use by a speech to project framework that first obtains consent to allow a speech to project framework to read a user's profile. The user may grant permission to continue.

A further extension may be used to invoke the recorder 110, such as Cortana® to capture human voice input. Cortana may welcome the user and request that the user dictate a requirement. The user may then dictate the requirement and provide a project and repository name to start a new repository or select an existing repository that the user has access to. Cortana may translate the human speech to text. The captured speech may be provided via a communication connection 115 to a speech to project engine 120 that converts the speech to text. In further embodiments, the text may be provided by recorder 110 comprising typed text on a mobile device such as a phone, laptop computer or other device suitable for capturing text from a user or users. The user may initiate a build project action by clicking on a button to upload the text output to the engine 120 via an API to the engine 120 used by the framework to start offline processing. A natural language processing device 125 receives the text and determines one or more intents from the text. Device 125 may utilize the natural language processing capabilities of Azure Cognitive services in one embodiment, or other similar service capable of deriving intents from text or speech. The intents are used to identify one or more of a software template and code components correlated to the intents.

The intents derived from human speech to converted text are used to extract the components from a mapping table containing intents and components. When the intents arrive, a lookup operation is performed to retrieve the required component. The table may include a library of components provided by one or more parties. In the case of multiple components corresponding to a single intent, the user may be given an option to select one or a combination of the multiple components. The components are stitched together to create the project. In other words, based the intent look-up various co related components are identified and the engine creates actual components and adds the components together into a functional project.

The engine 120 in one embodiment may use Visual Studio APIs or other development platform APIs to create a new branch by the project name which the user provided, and to upload the project output to this branch. Users will be notified via various means, such as email or text about the completion of the project creation process.

The generated template and code are provided via a connection 130 to a source repository 135, such as VSTS, GIT, or other means of storing and managing source code for software development projects. Even a simple data storage device may be used in further embodiments. The repository 135 is accessible via connections 140 and 141 by a development tool 145 such as Visual Studio or other software development tool or platform. A user of the tool 145 can retrieve the template and code and adapt it by adding further code in addition to the code associated with the intents derived from the text.

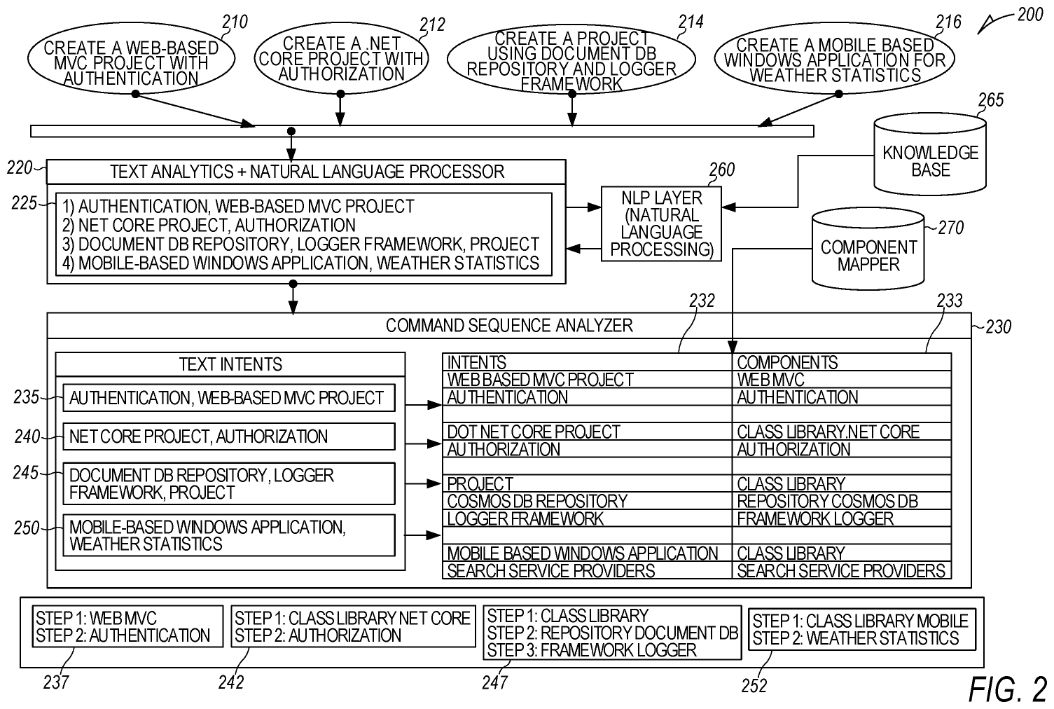

FIG. 2 is a block diagram illustrating further detail of the speech to project engine 120 generally at 200. Several examples of received text are shown at 210, 212, 214, and 216. Received text 210 describe a first project in the following manner: “Create a web-based MVC project with authentication.” Received text 212 describe a second project in the following manner: “Create a Net Core project with authentication.” Received text 214 describe a third project in the following manner: “Create a project using DB repository and logger framework.” Received text 210 describe a fourth project in the following manner: “Create a mobile based windows application for weather statistics.”

The above text examples may be derived from text converted speech that is dictated, typed, or otherwise generated. In one embodiment, the corresponding speech may be derived from a recording of a meeting. The entire meeting text may be used, or more likely, a specified portion of the meeting text where one or more users indicate that they are about to describe the requirements for a project, either orally, or by selecting an option, such as clicking a button as described above.

The example may be provided to a text analytics and natural language processor 220. The processor 220 takes input from the received text translated text and applies Text Analytics services to return a list of strings denoting the key talking points from the input text. In this technique, a natural language processing toolkit may be applied to get the meaningful intent out from those key phrases. The following example intents may be derived from the input text respectively:

First Project: Authentication, web-based MVC project

Second Project: Net Core project, authorization

Third Project: Document DB repository, logger framework, project

Fourth Project: Mobile-based Windows® application, Weather statistics

The intents for each of these projects may then be provided to a command sequence analyzer 230 where command sequence steps are generated for each project. Once meaningful Intents are derived, the Command Sequence analyzer processes on meaningful intent derived above to provide sequenced and processed command steps into the Engine Processor to get the functional code.

First project intents in the analyzer 230 are indicated at a column 232. A second column 233 indicates the corresponding components from the look-up table, component mapper 270. A first intent, 235 result in steps 237: “Step 1: Web MVC; Step 2: Authentication.” Second project intents in the analyzer 230 are indicated at 240 and result in steps 242: “Step 1: Class Library Net Core; Step 2: Authorization.” Third project intents in the analyzer 230 are indicated at 245 and result in steps 247: “Step1: Class Library; Step 2: Repository Document DB; Step 3: Framework Logger.” Fourth project intents in the analyzer 230 are indicated at 250 and result in steps 252: “Step 1: Class Library Mobile; Step 2: Weather Statistics.”

In one embodiment, processor 220 comprises a text analyzer that performed operations in a flow that receives the translated text and applies text analytics services via natural language processing (NLP) service 260 to return a list of strings denoting the key talking points from the input text. In this technique, a natural language processing mechanism from a knowledge base 265 is applied to process the text and get the meaningful intents from key phrases.

The derived intents extracted in this process are then passed to the command sequence analyzer 230 which takes the processed intents and performs a lookup on a component mapper 270 to find out the right components from the matching intents. The command sequence analyzer further performs a sequencing on the components to maintain the sequence order. The command sequencing helps the engine which is the main processing unit to take the sequenced command inputs from processed raw text to create a functional code.

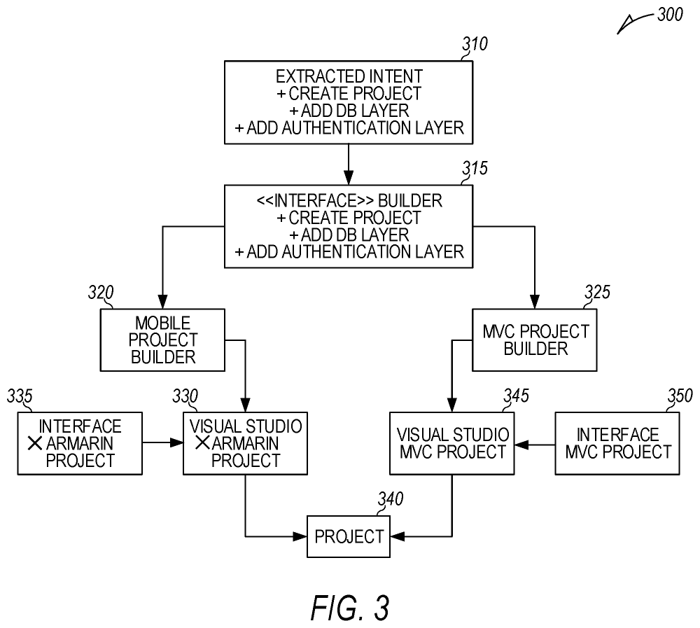

FIG. 3 is a flowchart illustrating a computer implemented method 300 of generating an example project from extracted intent at operation 310. The example project is expressed in the extracted intent operation 310 and includes steps of creating a project, adding a database layer, and adding an authentication layer.

An interface builder operation 315 includes the extracted intent corresponding steps that are inherited from operation 310. Each of the operations in FIG. 3 inherits extracted intent steps in one embodiment but are not shown for simplicity of illustration. Operation 315 branches between a mobile project builder operation 320 or an MVC project builder operation 325 depending on an option identified in the extracted intents.

Builder operation 320 includes a Development platform Xamarin project operation 330 that has an associated interface project operation 335. Each of the operations identify and stitch components together. The resulting project is indicated at 340, which may be stored in the repository. Builder operation 325 corresponds to the MVC project and includes a development platform MVC project with an associated interface project operation 350. The resulting project is also indicated at 340 and may be stored in the repository.

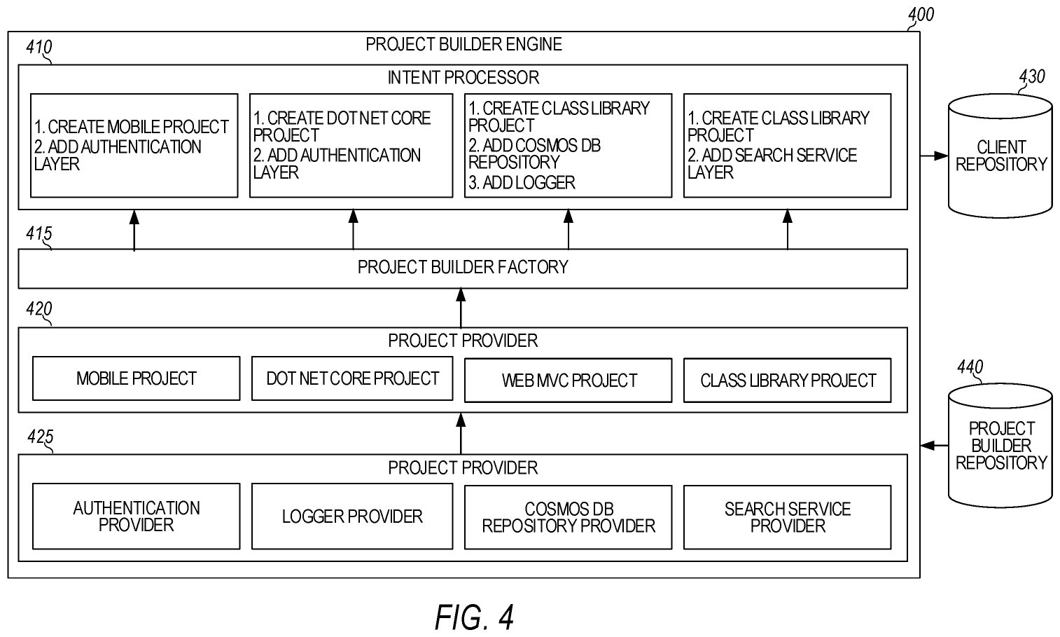

FIG. 4 is a block diagram providing further detail of the project builder engine at 400. Engine 400 includes an intent processor 410, a project builder factory 415, a project provider 420, and a feature provider 425. The engine 400 has access to a client repository 430 and a project builder repository 440.

Intent processor 410 includes several sets of intents derived from different projects that various users have described, either by speech converted to text, or text directly provided by the user. The project provider 420 has several different types of projects to select from, and the feature provider 425 includes several different providers for various features, such as authentication, logger, DB repository and search service provider. The feature providers be obtained from the project builder repository 440.

The project builder engine 400 mainly processes the user intent by creating the required project, adding the desired feature and uploading the source code/files to the client repository 430. FIG. 4 depicts the main building blocks of the project builder Engine 400.

Once the intent of the user is understood, project builder engine 400 starts processing each of the intents in sequence.

Intent processor invokes 410 the Project builder factory 415 to create a specific type of project (Mobile, Dot Net Core, etc.) and stitches them with additionally requested features like Authentication, Logger, Cosmos DB repository layer, etc.

Project builder factory 415 uses project providers 420 and corresponding feature providers 425 for a specific type of project.

Project and feature providers provide the source code for corresponding project types and features. These providers may internally use the project builder repository 440 to pick the generic project and feature files (csproj, cs, JSON, etc.) to expedite the process instead of writing the source code from scratch.

Project builder Factory 415 will stitch the empty project source code with the features requested by the user (Authentication, Logger, etc.), build the source code and upload the files to the client repository 430.

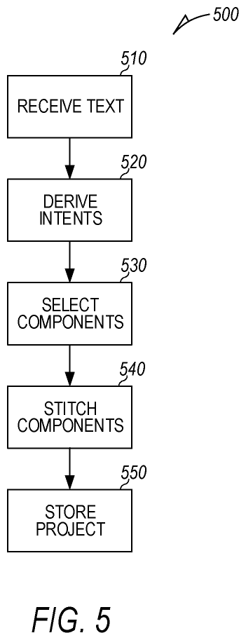

FIG. 5 is a flowchart illustrating a computer implemented method 400 of converting text representative of speech to development project code. The method may be performed by a computer in accordance with instructions of a framework of software components that instruct the computer to perform operations. Text describing a software development project is received at operation 510.

At operation 520, multiple project related intents are derived from the text using natural language processing services. Deriving multiple project intents at operation 520 may include generating a list of strings denoting the key talking points from the input text. A natural language processing toolkit may be applied to the list of strings denoting the key talking points to obtain the meaningful intents.

One or more software components corresponding to the derived intents are selected at operation 530. The multiple software components may be selected by applying a command sequence analyzer to each intent to obtain multiple corresponding command sequence steps. At operation 540, the multiple software components are stitched together to create development project code.

In one embodiment, receiving text at operation 510 includes receiving a recording of speech and recognizing the speech to create the text. The speech may have been captured during a meeting of multiple people via a meeting tool. The received text may also have included a project name. Method 500 may also include storing the development project code in a repository at operation 550, wherein the repository is specified by the received text.

In various embodiment, the software components include templates and code components. At least one of the selected software components may include one or more of an authentication component, an authorization component, a framework logger component, a class library mobile component, or a repository document database component.

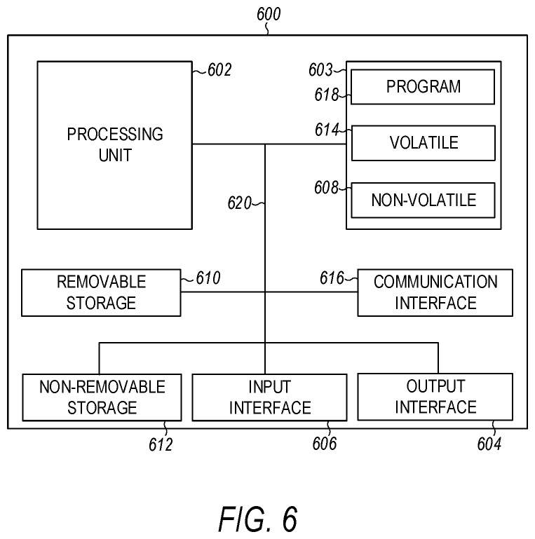

FIG. 6 is a block schematic diagram of a computer system 600 to implement one or more methods described herein to generate software project templates and code based on textual descriptions. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 618 along with the workspace manager 622 may be used to cause processing unit 602 to perform one or more methods or algorithms described herein.

### EXAMPLES

1. A computer implemented method includes receiving text describing a software development project, deriving multiple project related intents from the text using natural language processing services, selecting multiple software components corresponding to the derived intents, and stitching the multiple software components to create development project code.

2. The method of example 1 wherein receiving text includes receiving a recording of speech and recognizing the speech to create the text.

3. The method of example 2 wherein the recording of speech is captured during a meeting of multiple people via a meeting tool.

4. The method of any of examples 1-3 wherein the received text includes a project name.

5. The method of any of examples 1-4 and further comprising storing the development project code in a repository, wherein the repository is specified by the received text.

6. The method of any of examples 1-5 wherein the software components comprise templates and code components.

7. The method of any of examples 1-6 wherein at least one of the selected software components comprises an authentication component, an authorization component, a framework logger component, a class library mobile component, or a repository document database component.

8. The method of any of examples 1-7 wherein deriving multiple project intents comprises generating a list of strings denoting the key talking points from the input text.

9. The method of example 8 and further comprising applying a natural language processing toolkit to the list of strings denoting the key talking points to obtain the meaningful the intents.

10. The method of example 9 wherein selecting multiple software components comprises applying a command sequence analyzer to each intent to obtain multiple corresponding command sequence steps.

11. A machine-readable storage device has instructions for execution by a processor of a machine to cause the processor to perform operations to perform a method. The operations include receiving text describing a software development project, deriving multiple project related intents from the text using natural language processing services, selecting multiple software components corresponding to the derived intents, and stitching the multiple software components to create development project code.

12. The device of example 11 wherein the receiving text operation includes receiving a recording of speech and recognizing the speech to create the text.

13. The device of example 12 wherein the recording of speech is captured during a meeting of multiple people via a meeting tool.

14. The device of any of examples 11-13 wherein the received text includes a project name and wherein the operations further comprise storing the development project code in a repository, wherein the repository is specified by the received text.

15. The device of any of examples 11-14 wherein at least one of the selected software components comprises an authentication component, an authorization component, a framework logger component, a class library mobile component, or a repository document database component.

16. The device of any of examples 11-15 wherein deriving multiple project intents comprises generating a list of strings denoting the key talking points from the input text and wherein the operations further comprise applying a natural language processing toolkit to the list of strings denoting the key talking points to obtain the meaningful the intents.

17. The device of example 16 wherein selecting multiple software components comprises applying a command sequence analyzer to each intent to obtain multiple corresponding command sequence steps.

18. A device includes a processor and a memory device coupled to the processor and having a program stored thereon for execution by the processor to perform operations. The operations include receiving text describing a software development project, deriving multiple project related intents from the text using natural language processing services, selecting multiple software components corresponding to the derived intents, and stitching the multiple software components to create development project code.

19. The device of example 18 wherein the receiving text operation includes receiving a recording of speech, and recognizing the speech to create the text.

20. The device of any of examples 18-19 wherein deriving multiple project intents comprises generating a list of strings denoting the key talking points from the input text and wherein the operations further comprise applying a natural language processing toolkit to the list of strings denoting the key talking points to obtain the meaningful the intents and wherein selecting multiple software components comprises applying a command sequence analyzer to each intent to obtain multiple corresponding command sequence steps.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving text describing a software development project;
deriving multiple project related intents from the text using natural language processing services;
selecting multiple software components corresponding to the derived intents; and
stitching the multiple software components to create development project code.

2. The method of claim 1 wherein receiving text comprises:
receiving a recording of speech; and
recognizing the speech to create the text.

3. The method of claim 2 wherein the recording of speech is captured during a meeting of multiple people via a meeting tool.

4. The method of claim 1 wherein the received text includes a project name.

5. The method of claim 1 and further comprising storing the development project code in a repository, wherein the repository is specified by the received text.

6. The method of claim 1 wherein the software components comprise templates and code components.

7. The method of claim 1 wherein at least one of the selected software components comprises an authentication component, an authorization component, a framework logger component, a class library mobile component, or a repository document database component.

8. The method of claim 1 wherein deriving multiple project intents comprises generating a list of strings denoting the key talking points from the input text.

9. The method of claim 8 and further comprising applying a natural language processing toolkit to the list of strings denoting the key talking points to obtain the meaningful the intents.

10. The method of claim 9 wherein selecting multiple software components comprises applying a command sequence analyzer to each intent to obtain multiple corresponding command sequence steps.

11. A machine-readable storage device having instructions for execution by a processor of a machine to cause the processor to perform operations to perform a method, the operations comprising:
receiving text describing a software development project;
deriving multiple project related intents from the text using natural language processing services;
selecting multiple software components corresponding to the derived intents; and
stitching the multiple software components to create development project code.

12. The device of claim 11 wherein the receiving text operation comprises:
receiving a recording of speech; and
recognizing the speech to create the text.

13. The device of claim 12 wherein the recording of speech is captured during a meeting of multiple people via a meeting tool.

14. The device of claim 11 wherein the received text includes a project name and wherein the operations further comprise storing the development project code in a repository, wherein the repository is specified by the received text.

15. The device of claim 11 wherein at least one of the selected software components comprises an authentication component, an authorization component, a framework logger component, a class library mobile component, or a repository document database component.

16. The device of claim 11 wherein deriving multiple project intents comprises generating a list of strings denoting the key talking points from the input text and wherein the operations further comprise applying a natural language processing toolkit to the list of strings denoting the key talking points to obtain the meaningful the intents.

17. The device of claim 16 wherein selecting multiple software components comprises applying a command sequence analyzer to each intent to obtain multiple corresponding command sequence steps.

18. A device comprising:
a processor; and
a memory device coupled to the processor and having a program stored thereon for execution by the processor to perform operations comprising:
receiving text describing a software development project;
deriving multiple project related intents from the text using natural language processing services;
selecting multiple software components corresponding to the derived intents; and
stitching the multiple software components to create development project code.

19. The device of claim 18 wherein the receiving text operation comprises:
receiving a recording of speech; and
recognizing the speech to create the text.

20. The device of claim 18 wherein deriving multiple project intents comprises generating a list of strings denoting the key talking points from the input text and wherein the operations further comprise applying a natural language processing toolkit to the list of strings denoting the key talking points to obtain the meaningful the intents and wherein selecting multiple software components comprises applying a command sequence analyzer to each intent to obtain multiple corresponding command sequence steps.
